(19) United States
(12) Patent Application Publication
(10) Pub. No.: US 2026/0077292 A1
(43) Pub. Date: Mar. 19, 2026

(54) GAS SEPARATION USING MULTILAYER SORBENT COMPOSITES

(71) Applicant: Saudi Arabian Oil Company, Dhahran (SA)

(72) Inventors: Mourad Younes, Dhahran (SA); Nawal Alghoraibi, Riyadh (SA); Ammar Alahmed, Al-Khobar (SA); Aqil Jamal, Dhahran (SA)

(21) Appl. No.: 18/887,794

(22) Filed: Sep. 17, 2024

(51) Int. Cl. B01D 53/04

(52) U.S. Cl. CPC B01D 53/0407; B01D 53/0454; B01D 2257/504; B01D 2259/40086; B01D 2259/4145

(57) ABSTRACT

A multilayer composite sorbent stack is used for gas separation. A gas feed stream is fed into a vessel that includes the multilayer composite sorbent stack. The multilayer composite sorbent stack includes several sorbent layers alternated with insulation layers, such that the insulation layer is placed between two sorbent layers. The active sorbent layer selectively adsorbs a specific gas molecule from the gas feed stream. Upon determining that the active sorbent layer is saturated with the adsorbed gas molecule, the active sorbent layer is regenerated to release the adsorbed gas molecule. If the active sorbent layer degrades or underperforms due to gas saturation, the insulation layer beneath the active sorbent layer is partially or completely exfoliated, thereby exposing the next sorbent layer to the incoming gas feed stream to continue the selective adsorption or desorption process.

### TECHNICAL FIELD

This disclosure relates to methods of gas separation.

### BACKGROUND

With an increasing carbon footprint and climate change concerns, changes are being made to reduce greenhouse gas emissions. Carbon capture, utilization, and storage (CCUS) technologies offer solutions to mitigate carbon emissions. The methods of carbon capture technologies involve the use of a liquid solvent or a solid sorbent to bind the carbon dioxide (CO₂) from a gas stream, by physical or chemical mechanisms. In many carbon capture processes, the capture of CO₂ is performed using an amine-based solvent as it has a good affinity for CO₂ and a high absorption capacity. Once the liquid solvent or solid sorbent is saturated with CO₂, the CO₂ capture material undergoes a regeneration step to release the CO₂. However, these technologies are limited by the high regeneration temperatures, short life cycles, or low sorbent lifetimes, which lead to an increase in operating and maintenance costs. Finding the optimum balance between gas adsorption capacity, ease of regeneration, and cyclic stability is essential for reducing the total cost of capture, and the commercial adoption of carbon capture technologies.

### SUMMARY

An implementation described herein provides a method for gas separation. In some implementations, the method includes flowing a feed gas stream into a vessel, where the vessel includes a multilayer sorbent stack, where an insulation layer separates two adjacent sorbent layers in the multilayer sorbent stack; contacting the feed gas stream with a first sorbent layer in the multilayer sorbent stack, where the first sorbent layer selectively adsorbs a gas from the feed gas stream; determining a degradation of the first sorbent layer; removing partially or completely a first insulation layer, in response to determining the degradation of the first sorbent layer, therefore exposing a second sorbent layer; contacting the feed gas stream with a second sorbent layer, where the second sorbent layer selectively adsorbs the gas from the feed gas stream; and removing a depleted feed gas stream through an outlet of the vessel, where the depleted feed gas stream is depleted of the gas adsorbed by the first sorbent layer and the second sorbent layer.

In some implementations, the method further includes regenerating the first sorbent layer from the multilayer sorbent stack to release the gas adsorbed, after the first sorbent layer is saturated with the gas.

In some implementations, regenerating the first sorbent layer is performed by thermal heat cycle, pressure swing, vacuum, microwave, or electrical techniques.

In some implementations, the gas is selectively adsorbed from the feed gas stream that includes carbon dioxide (CO₂), carbon monoxide (CO), methane (CH₄), sulfur dioxide (SO₂), hydrogen (H₂), ammonia (NH₃), water vapor, nitrogen oxides (NOₓ), or hydrogen sulfide (H₂S).

In some implementations, the multilayer sorbent stack includes N number of sorbent layers and N-1 number of insulation layers, where N is an integer between 1 to 1000.

In some implementations, the N sorbent layers include metal organic frameworks (MOFs), covalent organic frameworks (COFs), hydrogen-bonded covalent frameworks, zeolites, zeolitic nanosheets, carbon-based materials, or polymers.

In some implementations, removing the first insulation layer includes removing the first insulation layer by an external stimulus.

In some implementations, the external stimulus includes chemical, thermal, radiation, mechanical, electrical, or microwave stimuli.

In some implementations, the method further includes using a wash fluid in the vessel to wash out a residue in the vessel, in response to removing the first insulation layer and before contacting the second sorbent layer.

In some implementations, the method further includes using a sweep gas to remove the depleted feed gas stream from the vessel.

An implementation described herein provides a system for gas separation. In some implementations, the system includes a vessel with a gas feed inlet, a sweep gas inlet, and a gas feed outlet; a support material placed inside the vessel; several solid sorbent layers stacked on top of the support material in the vessel; an insulation layer separating each of the several solid sorbent layers, where the insulation layer is configured to be removed by an external stimulus.

In some implementations, the gas feed inlet is configured to receive a mixture of gases that include carbon dioxide (CO₂), carbon monoxide (CO), methane (CH₄), sulfur dioxide (SO₂), nitrogen (N₂), oxygen (O₂), water vapor, hydrogen (H₂), ammonia (NH₃), nitrogen oxides (NOₓ), or hydrogen sulfide (H₂S).

In some implementations, each of the several solid sorbent layers is configured to selectively adsorb a gas from the mixture of gases that include CO₂, CO, CH₄, SO₂, N₂, O₂, water vapor, H₂, NH₃, NOₓ, or H₂S, and each of the several solid sorbent layers is configured to be regenerated by releasing the gas adsorbed.

In some implementations, each of the several solid sorbent layers includes metal organic frameworks (MOFs), covalent organic frameworks (COFs), hydrogen-bonded covalent frameworks, zeolites, zeolitic nanosheets, carbon-based materials, or polymers.

In some implementations, the thickness of each of the several solid sorbent ranges between 1 µm to 10 cm.

In some implementations, the thickness of the insulation layer is between 0.1 nm to 1 mm.

In some implementations, the external stimulus includes chemical, thermal, radiation, mechanical, electrical, microwave stimuli or as a function of time.

In some implementations, the sweep gas inlet is configured to receive a sweep gas, where the sweep gas is used to remove the mixture of gases through the gas feed outlet.

An implementation described herein provides a method for carbon dioxide (CO₂) separation. In some implementations, the method includes receiving a mixture of gases through an inlet of a reactor, where the reactor includes a multilayer solid sorbent stack, where each of a solid sorbent layer in the multilayer solid sorbent stack is separated by an insulation layer; selectively adsorbing CO₂ from the mixture of gases by the solid sorbent layer in the multilayer solid sorbent stack; regenerating the solid sorbent layer by releasing the adsorbed CO₂; determining a degradation of the solid sorbent layer; removing fully or partially the insulation layer by an external stimuli, in response to the degradation of the solid sorbent layer therefore exposing an adjacent solid sorbent layer; contacting the mixture of gases with the adjacent solid sorbent layer to selectively adsorb CO₂; releasing CO₂ from the adjacent solid sorbent layer by using heat, vacuum, a sweep gas, or a combination of them; and flowing the CO₂ through an outlet of the reactor.

In some implementations, the multilayer solid sorbent stack includes metal organic frameworks (MOFs), hydrogen-bonded covalent frameworks, covalent organic frameworks (COFs), zeolites, zeolitic nanosheets, carbon-based materials or polymers.

### BRIEF DESCRIPTION OF DRAWINGS

FIG. 1 is a schematic representation of a multilayer composite sorbent assembly for gas separation.

FIG. 2 is a schematic representation of the exfoliation mechanism of the insulation layer in the multilayer composite sorbent stack.

FIG. 3 is a schematic representation of a partial destruction of the insulation layer.

FIG. 4 is a process flow diagram of gas separation using a multilayer composite sorbent stack.

### DETAILED DESCRIPTION

Solid-based sorbents (hereafter referred to as solid sorbents) have a competitive CO₂ adsorption capacity but have a short sorbent lifetime when exposed to oxygen at high temperatures. Solid sorbents are operated in a batch or continuous process. During the adsorption and the regeneration cycles, the solid sorbents undergo temperature and pressure changes. The change in temperature and pressure can affect the solid sorbent’s lifetime. Further, exposure to oxygen (O₂) gas can degrade the solid sorbent. Therefore, the regeneration efficiency of a solid sorbent can be controlled by either optimizing the material of the solid sorbent or optimizing the system configuration.

Implementations disclosed herein relate to a system and method of using a multilayer composite sorbent assembly for particles adsorption and separation. The particles can include gas or liquid species. The multilayer composite sorbent assembly can be used effectively and efficiently. Further, the multilayer composite sorbent assembly does not require frequent replacement. The multilayer composite sorbent assembly and method can be used to adsorb any type of gas or liquid by modifying the sorbent material and chemistry.

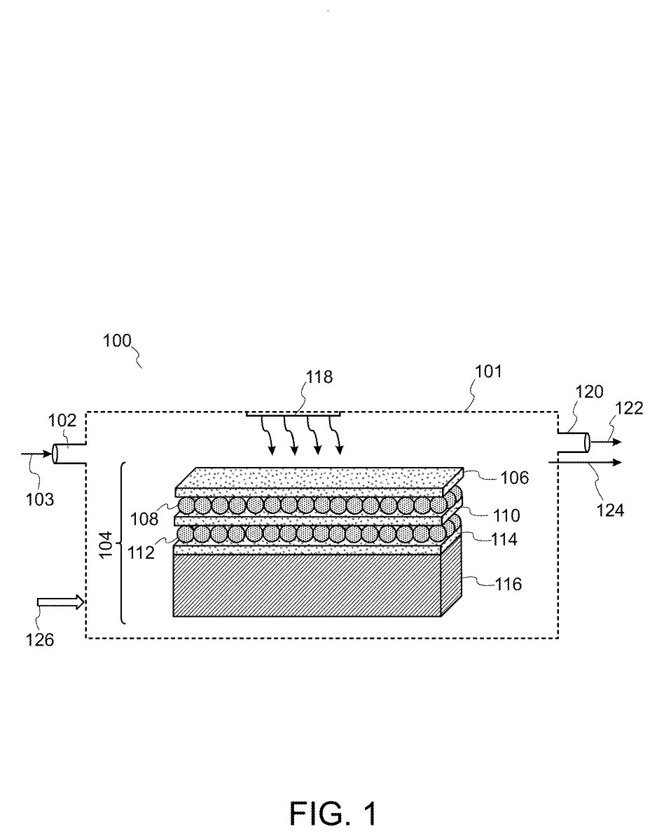

FIG. 1 is a schematic representation of a multilayer composite sorbent assembly 100 for gas separation. In some implementations, the multilayer composite sorbent assembly is placed in a vessel. In some implementations, the vessel includes a reactor. A reactor 101 includes a gas feed inlet 102 through which a feed gas stream 103 flows. In some implementations, a vessel is used in the place of a reactor. In some implementations, the feed gas stream 103 includes flue gas, acidic gas streams, sulfur-containing gases, air, or a mixture of gases that include predominantly CO₂. In some implementations, the feed gas stream includes, but is not limited to, carbon dioxide (CO₂), carbon monoxide (CO), methane (CH₄), sulfur dioxide (SO₂), hydrogen, ammonia (NH₃), water vapor, nitrogen oxides, and hydrogen sulfide (H₂S).

A multilayer composite sorbent stack 104 is placed inside the reactor 101, which is used to separate gas mixtures. The multilayer composite sorbent stack 104 includes a first sorbent layer 106 layered in conjunction with a first insulation layer 108 on a parallel plane. The multilayer composite sorbent stack 104 can be positioned in any direction in space.

In FIG. 1, the first insulation layer 108 is placed beneath the sorbent layer 106 which is alternated by another sorbent and insulation layer. For example, in the multilayer composite sorbent stack 104, a second sorbent layer 110 is placed beneath the first insulation layer 108. A second insulation layer 112 is placed beneath the second sorbent layer 110. A third sorbent layer 114 is placed beneath the second insulation layer 112. In this way the sorbent layer alternates with the insulation layer. The insulation layer isolates the underlying sorbent layer during an active gas separation process, thereby protecting the underlying sorbent layer. In some implementations, the sides of the multilayer composite sorbent stack 104 are isolated by a material to prevent gas permeation from the sides.

In some implementations, the multilayer composite sorbent stack 104 is designed such that it includes N number of sorbent layers and N-1 number of insulation layers, where N is an integer. In some implementations, the multilayer composite sorbent stack 104 includes N sorbent layers and N insulation layers. N can include a number between 1 to 1000. In some implementations, N is between 1 and 10. In some implementations, the multilayer assembly of the sorbent and insulation layers can be stacked in a vertical direction, where the sorbent layer and insulation layers can be placed adjacent to each other.

In some implementations, the last sorbent layer is placed on an inactive support material 116. In some implementations, the insulation layer is placed on the inactive support material 116. The inactive support material 116 can include monolith, honeycomb, planar, tubular, mesh, or laminate geometries. The inactive support material 116 can include any material known to the person skilled in the art such as ceramic, metallic, polymer, or resins.

When a feed gas stream 103 is fed into the reactor 101, the feed gas stream 103 contacts the first sorbent layer 106. The first sorbent layer 106 is the active sorbent layer as it selectively adsorbs the gas species from the entering gas mixture. The first insulation layer 108 prevents the feed gas stream 103 from contacting the second sorbent layer 110.

In implementations herein, a process for CO₂ gas adsorption and separation is described. The first sorbent layer 106 adsorbs CO₂ from the feed gas stream 103. The material of the sorbent layer can be modified by changing the chemistry or structure of the sorbent layer to selectively adsorb any of the particles from the inlet mixture. After the CO₂ adsorption takes place, an effluent stream 122 depleted of CO₂ exits the reactor 101 via the outlet 120.

As the first sorbent layer 106 actively adsorbs CO₂, it reaches a saturation level or a specific CO₂ loading. In some implementations, the effluent stream 122 is monitored. Once the CO₂ in the effluent stream 122 reaches above a pre-determined threshold, the first sorbent layer 106 is brought into a regeneration phase to release the adsorbed CO₂. In some implementations, the regeneration phase of the first sorbent layer 106 is carried out by thermal heat cycle, pressure swing, vacuum, microwave, or by electrical means.

During the regeneration phase, the reactor 101 enclosure is closed and isolated and the multilayer composite sorbent stack 104 is heated. In some implementations, a vacuum is created in the reactor enclosure, and or a sweep gas 118 is injected into the reactor 101 to help with the regeneration of the first sorbent layer 106. The sweep gas can include steam, an inert gas such as nitrogen, or a reactive gas such as hydrogen. After the regeneration phase, the desorbed CO₂ and sweep gas 118 exit the reactor 101 through the outlet stream 124.

During the regeneration phase, the insulation layer 108 protects the underlying layer from degradation. The choice of both the sorbent material and the insulation material are designed to ensure that the non-active sorbent layers (layers beneath the isolation layer 108) are unaffected during the adsorption and regeneration process.

Similarly, after the regeneration phase, the outlet stream 124 is monitored. Once the CO₂ level reaches a pre-determined threshold concentration, the regeneration process is stopped. In some implementations, the regeneration is stopped when the CO₂ loading on the first sorbent layer 106 reaches a specific CO₂ level or following a specific time stamp. The reactor 101 and the first sorbent layer 106 are brought to the initial conditions which are suitable for a new cycle of CO₂ capture.

As the process goes through several CO₂ capture cycles, the first sorbent layer 106 degrades and underperforms. This is referred to as a spent sorbent. In such cases, the first insulation layer 108 is exfoliated (peeled or removed) to establish contact of the feed gas stream 103 with the second sorbent layer 110, making the second sorbent layer the active layer. The isolation layer 108 is exfoliated by an external stimuli after a specific time, a specific number of cycles, or when the capture performance degrades below a specific threshold. The external stimuli can include chemical addition, temperature increase, exposure to radiation, mechanical stimuli, magnetic field, electricity, electromagnetic, or microwave means. The specific time after which exfoliation is carried out can include time in the order of days or months and even years. In some implementations, exfoliation is carried out after 4 months to 2 years. Each active layer (in this example the first sorbent layer 106) can undergo hundreds to thousands of cycles. As the second sorbent layer 110 undergoes CO₂ adsorption and regeneration, the second sorbent layer 110 degrades as well. In such cases, the second insulation layer 112 is exfoliated to expose the third sorbent layer 114 to the incoming feed gas stream 103. This process continues as long as N number of sorbent layers are spent.

The sorbent layers can have a thickness in a range of about 1 µm to 10 cm. In some implementations, the sorbent layers have a thickness in the range of about 10 µm to 1 mm. In the example of CO₂ capture application, the sorbent layer is a porous material with great affinity to CO₂. In some implementations, the sorbent layer material includes metal organic frameworks (MOFs), covalent organic frameworks (COFs), hydrogen-bonded organic frameworks, zeolites, carbon-based materials, or polymers. In some implementations, highly permeable 2D sheet structures such as zeolitic nanosheets are used. In some implementations, the zeolitic nanosheets include zeolitic bis-1,5-(tripropyl ammonium) pentamethylene (dC5) nanosheets. In some implementations, mesh-adjusted molecular sieve (MAMS-layered) MOF is used. In addition, another property for CO₂ capture is the formation of 2D structures that enable electrostatic interactions with the corresponding insulation layer. The property for any of the gas species capture depends on the properties of the sorbent and the adsorbing species.

The insulation layer can have a thickness in the range of about 0.1 nm to 1 cm. In some implementations, the insulation layer has a thickness in the range of about 1 µm to 1 mm. In some implementations, the insulation layer is non-porous and fluidically isolates the feed gas stream 103 from the adjacent non-active sorbent layer (the non-adsorbing sorbent layer). In some implementations, the insulation layer is semi-porous and isolates the molecules or species from the feed gas stream 103 that are harmful to the adjacent non-active sorbent layer, while allowing other non-harmful molecules to contact the adjacent non-active sorbent layer.

In some implementations, instead of exfoliating the insulation layer, it is destroyed on demand and loses its insulating property, thus making the insulation layer porous to all molecules, specifically porous to the molecules that needs separation. In this example, the molecule that needs separation is CO₂. However, the loss of the insulation property does not impact the adjacent spent sorbent layer (first sorbent layer 106). In such cases, the spent sorbent layer (in this case the first sorbent layer 106) continues to operate as part of the system, but eventually can cause slowdown in the diffusion of the molecules across the spent sorbent layer to reach the next new sorbent layer. While this slowdown can be a drawback, having the spent sorbent layers operational can lead to more capture capacity, as these layers would not be completely inactive and can help capture some CO₂. Moreover, the spent sorbent layer can slow down the contaminants from getting into the deeper new sorbent layers considering the diffusion of the gas molecules across the spent sorbent layer. This can increase the lifetime of the newer sorbent layers.

In some implementations, the multilayer composite sorbent stack 104 includes sorbent layers with similar structure and thickness. In some implementations, the multilayer composite sorbent stack 104 includes sorbent layers with different rheology, structures, and/or thickness. For example, the first sorbent layer 106 is designed with large macro-pores or channels as it is the first layer in contact with the incoming feed gas stream 103. Further, the large macro-pores or channels facilitate the gas molecules to move freely to the subsequent layers when the insulating property of the insulation layer is destroyed, but the insulation layer is still present in the stack and not exfoliated (removed from the system) In some implementations, the last sorbent layer is designed with tighter pore structures as diffusion through the last sorbent layer is not required.

In some implementations, when the exfoliation of the insulation layer 108 occurs, the spent first sorbent layer 106 is destroyed and removed as well. The removal of the first sorbent layer 106 and the first insulation layer 108 exposes the second sorbent layer 110 to the feed gas stream 103. In this case, the first insulation layer 108 can be designed to be biodegradable. Hence, any residue of the first insulation layer 108 that is not removed from the reactor 101 can biodegrade inside the reactor 101, without causing damage to the system. In some implementations, the exfoliation of any of the insulation layers is done while the reactor 101 is closed. A wash fluid 126 is introduced into the reactor 101 to wash out all residue following the exfoliation. The residue along with the wash fluid 126 is drained out of the reactor 101.

In some implementations, while activating any of the sorbent layers or exfoliating any of the insulation layers, filters are placed at the outlet of the reactor 101 to remove the solid residue that can escape the reactor 101. The filters can be of bag or rigid types. They are used to trap the solid particles. They can be chosen from a variety of types and designs. The filter performance can range from a minimum efficiency reporting value (MERV) of about 1 to 20. In some implementations, the filters are chosen with a MERV of about 9 to 19.

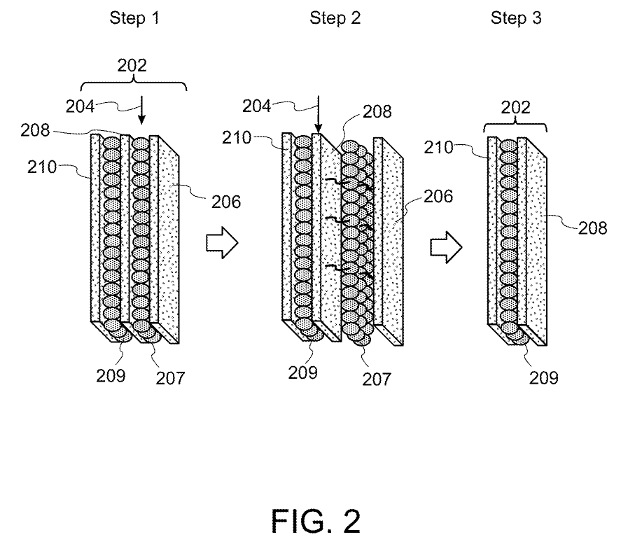

FIG. 2 is a schematic representation of the exfoliation mechanism of the insulation layer in the multilayer composite sorbent stack. A multilayer sorbent composite stack 202 includes a sorbent layer that alternates with an insulation layer. The first sorbent layer 206 is placed adjacent to the first insulation layer 207. A second sorbent layer 208 is sandwiched between the first insulation layer 207 and the second insulation layer 209. This is followed by a third sorbent layer 210.

An external stimulus 204 is applied to the first insulation layer 207. As described in FIG. 1, the external stimulus can include chemical addition, temperature increase, exposure to radiation, mechanical stimuli, magnetic field, electricity, electromagnetic, or microwave induced mechanisms. In step 1 of FIG. 2, the external stimulus 204 breaks the first insulation layer 207. In some implementations, the external stimulus 204 breaks the bond both between the first insulation layer 207 and the first sorbent layer 206, and the second sorbent layer 208 and the first insulation layer 207. This exfoliates the first sorbent layer 206 and the first insulation layer 207.

In some implementations, the first insulation layer 207 is degraded or dissolved directly following the exposure to the external stimulus 204. In some implementations, the insulation layers are oxo-degraded or they disintegrate over time without an external stimulus 204 other than the stimuli received during regular operation. In such cases, the insulation layers are designed to have different timelines of disintegration so that they disintegrate sequentially with a time shift, thereby allowing for a longer operation time.

In step 2 of FIG. 2, after the application of the external stimulus 204, the first sorbent layer 206 and the first insulation layer 207 are exfoliated and removed. The residue of the first sorbent layer 206 and the first insulation layer 207 are removed from the reactor using a wash fluid or by means of filter (described in FIG. 1). The feed gas stream entering the reactor contacts the second sorbent layer 208. In step 3, the second sorbent layer 208 degrades or underperforms and the exfoliation process is repeated for the second insulation layer 209 and the second sorbent layer 208. This exposes the third sorbent layer 210 for gas adsorption. This process goes on until the final sorbent layer underperforms in the multilayer sorbent composite stack 202.

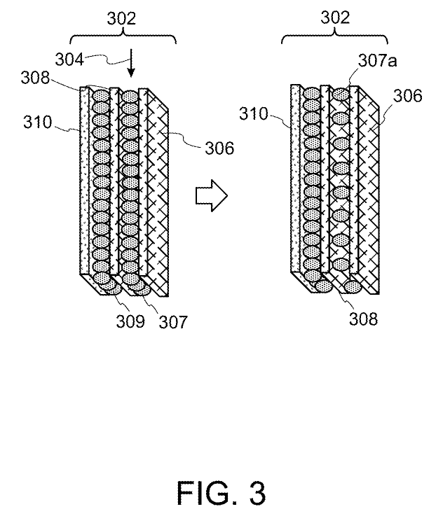

FIG. 3 is a schematic representation of a partial destruction of the insulation layer. A multilayer composite sorbent stack 302 includes a first sorbent layer 306, a first insulation layer 307, a second sorbent layer 308, a second insulation layer 309, and a third sorbent layer 310. The first and second sorbent layers (306, 308) are designed with macro pores or microchannels. When the first sorbent layer 306 underperforms, an external stimulus 304 is applied to the first insulation layer 306. The external stimulus 304 partially deactivates, destroys, or makes the first insulation layer 307 porous to various gases. In this case, the gas molecules from the feed gas stream diffuses through the first sorbent layer 306 and then through the first porous insulation layer 307a before contacting the second sorbent layer 308. The selection of the sorbent material and the corresponding insulation layer impact the partial destruction mechanism and the regeneration mechanism.

In some implementations, the exfoliation mechanism for either partial or complete exfoliation is carried out by a mechanical stimulus. For example, the layers can be exfoliated by a mechanical stimulus such as sonication, ball milling, or scrapping. In some implementations, a top-down delamination method works best for laminated sheets bound by weak van der Waals interactions. However, the delamination method is difficult to control, especially in a large-scale process. There is a risk of fragmenting the insulation layers or sorbent layers and breaking down the entire multilayer composite sorbent stack structure.

In some implementations, the exfoliation mechanism is carried out by a thermal stimulus. Thermal based exfoliation depends on solid-liquid phase interchange. For example, MAMS-1 nanosheets can be exfoliated via solvent expansion induced by freeze-thaw cycle of an aprotic solvent (hexane). In some implementations, heat based annealing is used as the exfoliation method, where the difference in heat expansion coefficients between the bulk crystal (sorbent layer) and intercalating species (insulation layer) is the key driving force. The key in using thermal stimulus is the ability to change the temperature of the last sorbent layer \ while maintaining the integrity of the active sorbent layer.

In some implementations, the exfoliation mechanism is carried out by a chemical stimulus. Chemical stimulus includes a solvent based exfoliation, which uses protic solvents such as water, acids, amine, or alcohol. The hydrogen atom in the protic solvent can interact with the charged ions in the incoming feed gas stream resulting in the formation of gases that force the insulation layer and sorbent layer apart.

Similarly, aprotic solvents can coordinate with the charged ions and induce dispersion and separation of the insulation layers and sorbent layers. Depending on the anionic or cationic intercalating species in the insulation and sorbent layers, acid-base solvent interactions can be induced via solvent based exfoliation. In some implementations, chemicals such as trimethylphosphine is used as an exfoliating medium. Trimethylphosphine can selectively cleave the disulfide bond between 4,4′-dipyridyl disulfide layer and Zn₂(bim)₄ mesoporous silica nanoparticles (MSN) MOF nanosheets.

In some implementations, the exfoliation mechanism is carried out by an oxo-degradable mechanism. In some implementations, controlled oxidation of the intercalating layer in the insulation layer is a viable method of exfoliation. It can be applied to oxo-degradable layers such as boron nanosheets or tetrafluoroborate (BF₄) polyanions, that are used in the intercalating layer.

In some implementations, the exfoliation mechanism is carried out by an electric induced or electrochemical mechanism. For example, the electrochemical induced exfoliation is widely used due to its flexibility, tunability, and wide scale application. Electrochemical exfoliation can be induced by reversing the charge of the electrochemical cell. In this case the electrostatic charge holding the interlayers together is cleaved. In some implementations, redox reaction of the intercalating molecule in the insulation layer is induced, which disrupts the molecule interaction with the sorbent layer.

In some implementations, the exfoliation mechanism is carried out by a microwave induced mechanism. Microwave induced exfoliation has tunable potential. The targeted application of microwaves can cleave the binding between the sorbent and insulation layers of the multilayer composite stack directly or indirectly via solvent evaporation. In this mechanism, the insulation layer has to be microwave active, while the active sorbent layer is microwave inactive. For example, hexafluorophosphate (PF₆) containing ionic liquids exhibit microwave activity, enabling efficient and stable exfoliation of MoS₂ nanosheets. In some implementations, the microwave exfoliation mechanism relies on evaporation of low boiling point solvents, such as tetrahydrofuran or acetonitrile.

In some implementations, the exfoliation is carried out by exposure to radiation, such as via an ultraviolet (UV) induced mechanism. Light irradiation by UV could be challenging because many active sorbents are sensitive to UV irradiation. For example, a short exposure of graphene nanolayers to UV exfoliates the layers into graphene monolayers via protic solvents (dimethylformamide). In this case UV irradiation on the graphene activates it by deoxygenating the reduced graphene oxide (rGO) and forming monolayered nanosheets. Some materials run the risk of degrading under prolonged exposure to UV. In some implementations, special materials such as reversable MOF are used as a stable active sorbent layer.

In some implementations, external stimuli that can induce exfoliation of the insulation layer include laser induction and targeted plasma activation. The active solid sorbent material has to be resistant to the exfoliation mechanism, while the corresponding insulation material has to be resistant to the regeneration mechanism. Therefore, careful selection of insulation material and sorbent material makes the process efficient and effective.

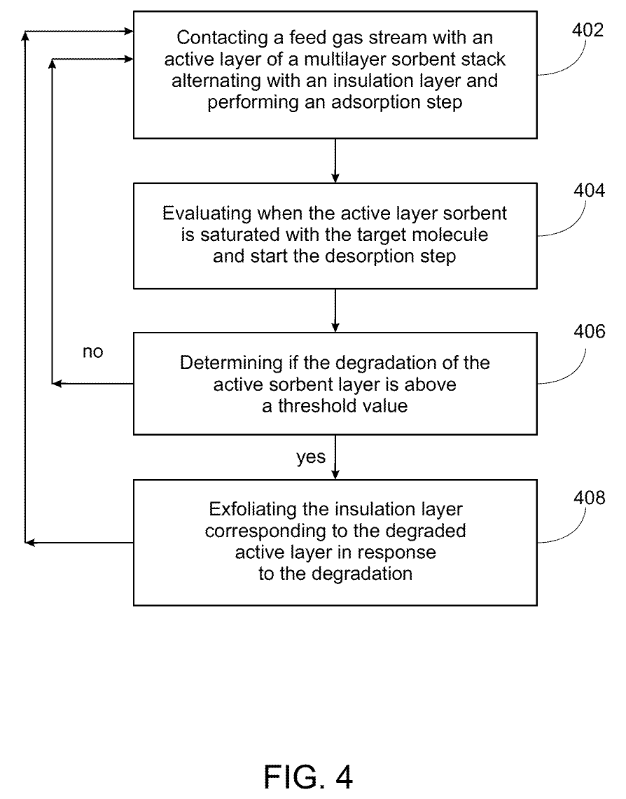

FIG. 4 is a process flow diagram of gas separation using a multilayer composite sorbent stack. At block 402, a feed stream is brought into contact with a multilayer composite sorbent stack adapted to adsorb specific molecules from the feed stream and allowing for a depleted stream to exit out of the stack. In some implementations, the feed stream includes flue gas, acidic gas streams, air, sulfur containing gases, a mixture of gases that include predominantly CO₂, or a mixture of liquids. The multilayer composite sorbent stack includes sorbent layers alternating with insulation layers. The sorbent layer can be modified to adsorb any gas species or liquid species. In some implementations, the first sorbent layer in the multilayer composite sorbent stack is contacted by the feed stream, which is also referred to as the active sorbent layer. The insulation layer protects the sorbent layer beneath it, for example the second sorbent layer, by preventing the feed stream molecules from contacting it.

At block 404, a determination is made about the active sorbent layer saturation with the selected molecule. In case it is determined that the active sorbent layer is saturated, the adsorption step can be stopped and the active sorbent layer can be regenerated (desorbed) to recover the adsorbed molecules from it. In some implementations, the adsorption by the first sorbent layer is stopped after a specific time period. Once the first sorbent layer is saturated with the target molecule, it is regenerated. In some implementations, regeneration of the first sorbent layer occurs by a thermal heat cycle, where the multilayer composite sorbent stack is heated to release the target molecule from the first sorbent layer. In some implementations, the target molecule adsorbed includes, but is not limited to, CO₂, SO₂, H₂S, NO₂, H₂, CO, CH₄, ammonia (NH₃), water vapor, and nitrogen oxides (NOₓ). In some implementations, the target molecules include liquid species or contaminants from a liquid mixture. In some implementations, regeneration occurs through vacuum, pressure swing method, microwave, or by electrical techniques.

At block 406, a determination is made about the degradation and underperformance of the first sorbent layer. For example, as the first sorbent layer undergoes various cycles of target molecule adsorption and desorption, it degrades over time. A performance evaluation is performed and benchmarked against a threshold value to determine when it is economical to activate the subsequent sorbent layer by exfoliating or partially destroying the corresponding insulation layer. If the first sorbent layer is still performing, the steps in blocks 402 and 404 are repeated. If the first sorbent layer is found to be underperforming, the process moves to block 408.

The insulation layer protects the underlying sorbent layers from degradation during the regeneration process. In some implementations, the insulation layer thickness is small that its impact on heat transfer is limited. In some implementations, the thermal conductivity of the insulation layer is low. In some implementations, the insulation layer is thick and has a thermal insulation effect which protects the underlying sorbent layers. The use of a thick insulation layer is useful when regeneration occurs using a sweep gas or when a microwave or induction heating is used in the exfoliation process.

At block 408, the insulation layer beneath the first sorbent layer is exfoliated or partially destroyed in response to determining a degradation of the first sorbent layer. Exfoliation mechanisms use an external stimuli. The external stimuli can include a chemical, thermal, radiation, mechanical, electrical, or microwave stimuli. The exfoliation mechanism removes or destroys the insulation layer beneath the first sorbent layer and exposes the second sorbent layer to the incoming feed stream. In some implementations, the exfoliation mechanism removes the first sorbent layer as well. The residue after the exfoliation process is removed from the reactor using a wash fluid, and the process is directed back to the steps in block 402.

Implementations described herein provide a system and method to use solid sorbents for gas separation. Implementations described herein provide a system and method for carbon capture. In traditional systems, the reactors are frequently shut down for replacement of solid sorbents due to the short lifetime of the solid sorbents. However, the implementations disclosed herein provide a solution to reduce the downtime associated with system shut down during sorbent replacement. Implementations described here provide a continuous and uninterrupted process for gas separation by using a multilayer composite sorbent stack assembly with a prolonged sorbent lifetime.

Implementations described here are used for carbon capture, H₂S capture, or sulfur containing gas separation. The system and method can be applied to direct air capture, point source capture, or mobile capture.

Other implementations are also within the scope of the following claims.

### Exemplary Embodiments

1. A gas separation method comprising:

flowing a feed gas stream into a vessel, wherein the vessel comprises a multilayer sorbent stack, wherein an insulation layer separates two adjacent sorbent layers in the multilayer sorbent stack;

contacting the feed gas stream with a first sorbent layer in the multilayer sorbent stack, wherein the first sorbent layer selectively adsorbs a gas from the feed gas stream;

determining a degradation of the first sorbent layer;

removing partially or completely a first insulation layer, in response to determining the degradation of the first sorbent layer, thereby exposing a second sorbent layer;

contacting the feed gas stream with a second sorbent layer, wherein the second sorbent layer selectively adsorbs the gas from the feed gas stream; and

removing a depleted feed gas stream through an outlet of the vessel, wherein the depleted feed gas stream is depleted of the gas adsorbed by the first sorbent layer and the second sorbent layer.

2. The method of embodiment 1, further comprising regenerating the first sorbent layer from the multilayer sorbent stack to release the gas adsorbed, after the first sorbent layer is saturated with the gas.

3. The method of embodiment 1 or 2, wherein regenerating the first sorbent layer is performed by thermal heat cycle, pressure swing, vacuum, microwave, or electrical techniques.

4. The method of any of embodiments 1 to 3, wherein selectively adsorbing the gas from the feed gas stream comprises selectively adsorbing carbon dioxide (CO₂), carbon monoxide (CO), methane (CH₄), sulfur dioxide (SO₂), hydrogen (H₂), ammonia (NH₃), water vapor, nitrogen oxides (NOₓ), or hydrogen sulfide (H₂S).

5. The method of any of embodiments 1 to 4, wherein the multilayer sorbent stack comprises N number of sorbent layers and N-1 number of insulation layers, wherein N is an integer between 1 to 1000.

6. The method of any of embodiments 1 to 5, wherein N sorbent layers comprise metal organic frameworks (MOFs), covalent organic frameworks (COFs), hydrogen-bonded covalent frameworks, zeolites, zeolitic nanosheets, carbon-based materials, or polymers.

7. The method of any of embodiments 1 to 6, wherein removing the first insulation layer comprises removing the first insulation layer by an external stimulus.

8. The method of any of embodiments 1 to 7, wherein the external stimulus comprises chemical, thermal, radiation, mechanical, electrical, or microwave stimuli.

9. The method of any of embodiments 1 to 8, further comprising using a wash fluid in the vessel to wash out a residue in the vessel, in response to removing the first insulation layer and before contacting the second sorbent layer.

10. The method of any of embodiments 1 to 9, further comprising using a sweep gas to remove the depleted feed gas stream from the vessel.

11. A gas separation system comprising:

a vessel comprising a gas feed inlet, a sweep gas inlet, and a gas feed outlet;

a support material placed inside the vessel;

a plurality of solid sorbent layers stacked on top of the support material in the vessel; and

an insulation layer separating each of the plurality of solid sorbent layers, wherein the insulation layer is configured to be removed by an external stimulus.

12. The system of embodiment 11, wherein the gas feed inlet is configured to receive a mixture of gases comprising carbon dioxide (CO₂), carbon monoxide (CO), methane (CH₄), sulfur dioxide (SO₂), nitrogen (N₂), oxygen (O₂), water vapor, hydrogen (H₂), ammonia (NH₃), nitrogen oxides (NOₓ), or hydrogen sulfide (H₂S).

13. The system of embodiment 11 or 12, wherein each of the plurality of solid sorbent layers is configured to selectively adsorb a gas from the mixture of gases comprising CO₂, CO, CH₄, SO₂, N₂, O₂, water vapor, H₂, NH₃, NOₓ, or H₂S, and each of the plurality of solid sorbent layers is configured to be regenerated by releasing the gas adsorbed.

14. The system of any of embodiments 11 to 13, wherein each of the plurality of solid sorbent layers comprises metal organic frameworks (MOFs), covalent organic frameworks (COFs), hydrogen-bonded covalent frameworks, zeolites, zeolitic nanosheets, carbon-based materials, or polymers.

15. The system of any of embodiments 11 to 14, wherein the thickness of each of the plurality of solid sorbent ranges between 1 µm to 10 cm.

16. The system of any of embodiments 11 to 15, wherein the thickness of the insulation layer is between 0.1 nm to 1 mm.

17. The system of any of embodiments 11 to 16, wherein the external stimulus comprises chemical, thermal, radiation, mechanical, electrical, microwave stimuli or as a function of time.

18. The system of any of embodiments 11 to 17, wherein the sweep gas inlet is configured to receive a sweep gas, wherein the sweep gas is used to remove the mixture of gases through the gas feed outlet.

19. A method of carbon dioxide (CO₂) separation using the system of claim 11, the method comprising:

receiving a mixture of gases through an inlet of the reactor, wherein the reactor comprises a multilayer solid sorbent stack, wherein each of a solid sorbent layer in the multilayer solid sorbent stack is separated by an insulation layer;

selectively adsorbing CO₂ from the mixture of gases by the solid sorbent layer in the multilayer solid sorbent stack;

regenerating the solid sorbent layer by releasing the adsorbed CO₂;

determining a degradation of the solid sorbent layer;

removing fully or partially the insulation layer by an external stimuli, in response to the degradation of the solid sorbent layer thereby exposing an adjacent solid sorbent layer;

contacting the mixture of gases with the adjacent solid sorbent layer to selectively adsorb CO₂;

releasing CO₂ from the adjacent solid sorbent layer by using heat, vacuum, a sweep gas, or a combination thereof; and

flowing the CO₂ through an outlet of the reactor.

20. The method of embodiment 19, wherein the multilayer solid sorbent stack comprises metal organic frameworks (MOFs), hydrogen-bonded covalent frameworks, covalent organic frameworks (COFs), zeolites, zeolitic nanosheets, carbon-based materials or polymers.

1. A gas separation method comprising:
flowing a feed gas stream into a vessel, wherein the vessel comprises a multilayer sorbent stack, wherein an insulation layer separates two adjacent sorbent layers in the multilayer sorbent stack;
contacting the feed gas stream with a first sorbent layer in the multilayer sorbent stack, wherein the first sorbent layer selectively adsorbs a gas from the feed gas stream;
determining a degradation of the first sorbent layer;
removing partially or completely a first insulation layer, in response to determining the degradation of the first sorbent layer, thereby exposing a second sorbent layer;
contacting the feed gas stream with a second sorbent layer, wherein the second sorbent layer selectively adsorbs the gas from the feed gas stream; and
removing a depleted feed gas stream through an outlet of the vessel, wherein the depleted feed gas stream is depleted of the gas adsorbed by the first sorbent layer and the second sorbent layer.

2. The method of claim 1, further comprising regenerating the first sorbent layer from the multilayer sorbent stack to release the gas adsorbed, after the first sorbent layer is saturated with the gas.

3. The method of claim 2, wherein regenerating the first sorbent layer is performed by thermal heat cycle, pressure swing, vacuum, microwave, or electrical techniques.

4. The method of claim 1, wherein selectively adsorbing the gas from the feed gas stream comprises selectively adsorbing carbon dioxide (CO₂), carbon monoxide (CO), methane (CH₄), sulfur dioxide (SO₂), hydrogen (H₂), ammonia (NH₃), water vapor, nitrogen oxides (NOₓ), or hydrogen sulfide (H₂S).

5. The method of claim 1, wherein the multilayer sorbent stack comprises N number of sorbent layers and N-1 number of insulation layers, wherein N is an integer between 1 to 1000.

6. The method of claim 5, wherein N sorbent layers comprise metal organic frameworks (MOFs), covalent organic frameworks (COFs), hydrogen-bonded covalent frameworks, zeolites, zeolitic nanosheets, carbon-based materials, or polymers.

7. The method of claim 1, wherein removing the first insulation layer comprises removing the first insulation layer by an external stimulus.

8. The method of claim 7, wherein the external stimulus comprises chemical, thermal, radiation, mechanical, electrical, or microwave stimuli.

9. The method of claim 1, further comprising using a wash fluid in the vessel to wash out a residue in the vessel, in response to removing the first insulation layer and before contacting the second sorbent layer.

10. The method of claim 1, further comprising using a sweep gas to remove the depleted feed gas stream from the vessel.

11. A gas separation system comprising:
a vessel comprising a gas feed inlet, a sweep gas inlet, and a gas feed outlet;
a support material placed inside the vessel;
a plurality of solid sorbent layers stacked on top of the support material in the vessel; and
an insulation layer separating each of the plurality of solid sorbent layers, wherein the insulation layer is configured to be removed by an external stimulus.

12. The system of claim 11, wherein the gas feed inlet is configured to receive a mixture of gases comprising carbon dioxide (CO₂), carbon monoxide (CO), methane (CH₄), sulfur dioxide (SO₂), nitrogen (N₂), oxygen (O₂), water vapor, hydrogen (H₂), ammonia (NH₃), nitrogen oxides (NOₓ), or hydrogen sulfide (H₂S).

13. The system of claim 11, wherein each of the plurality of solid sorbent layers is configured to selectively adsorb a gas from the mixture of gases comprising CO₂, CO, CH₄, SO₂, N₂, O₂, water vapor, H₂, NH₃, NOₓ, or H₂S, and each of the plurality of solid sorbent layers is configured to be regenerated by releasing the gas adsorbed.

14. The system of claim 11, wherein each of the plurality of solid sorbent layers comprises metal organic frameworks (MOFs), covalent organic frameworks (COFs), hydrogen-bonded covalent frameworks, zeolites, zeolitic nanosheets, carbon-based materials, or polymers.

15. The system of claim 14, wherein the thickness of each of the plurality of solid sorbent ranges between 1 µm to 10 cm.

16. The system of claim 11, wherein the thickness of the insulation layer is between 0.1 nm to 1 mm.

17. The system of claim 11, wherein the external stimulus comprises chemical, thermal, radiation, mechanical, electrical, microwave stimuli or as a function of time.

18. The system of claim 11, wherein the sweep gas inlet is configured to receive a sweep gas, wherein the sweep gas is used to remove the mixture of gases through the gas feed outlet.

19. A method of carbon dioxide (CO₂) separation using the system of claim 11, the method comprising:
receiving a mixture of gases through an inlet of the reactor, wherein the reactor comprises a multilayer solid sorbent stack, wherein each of a solid sorbent layer in the multilayer solid sorbent stack is separated by an insulation layer;
selectively adsorbing CO₂ from the mixture of gases by the solid sorbent layer in the multilayer solid sorbent stack;
regenerating the solid sorbent layer by releasing the adsorbed CO₂;
determining a degradation of the solid sorbent layer;
removing fully or partially the insulation layer by an external stimuli, in response to the degradation of the solid sorbent layer thereby exposing an adjacent solid sorbent layer;
contacting the mixture of gases with the adjacent solid sorbent layer to selectively adsorb CO₂;
releasing CO₂ from the adjacent solid sorbent layer by using heat, vacuum, a sweep gas, or a combination thereof; and
flowing the CO₂ through an outlet of the reactor.

20. The method of claim 19, wherein the multilayer solid sorbent stack comprises metal organic frameworks (MOFs), hydrogen-bonded covalent frameworks, covalent organic frameworks (COFs), zeolites, zeolitic nanosheets, carbon-based materials or polymers.
